(19) United States
(12) Patent Application Publication
(10) Pub. No.: US 2008/0125079 A1
(43) Pub. Date: May 29, 2008

(54) Methods, systems and computer products for remote monitoring and control of application usage on mobile devices

(76) Inventors: Douglas O'Neil, Marietta, GA (US); Stephen Sherman, Alpharetta, GA (US)

Correspondence Address: CANTOR COLBURN LLP - BELLSOUTH, 20 Church Street, 22nd Floor, Hartford, CT, 06103, US

(21) Appl. No.: 11/593,876

(22) Filed: Nov. 7, 2006

(51) Int. Cl. H04M 11/00

(52) U.S. Cl. 455/405

(57) ABSTRACT

Methods, systems and computer products for notifying a customer if particular telephone numbers are in communication with the mobile network, and when a particular application associated with the telephone numbers are in use. Exemplary embodiments include a methods, systems and computer products for providing a mobile network notification service, including establishing a notification relationship between a device and the mobile network, monitoring the device for application usage on the network, generating a notification on the network related to the application usage and in response to the notification, generating a response to the application usage.

### BACKGROUND

The present disclosure relates generally to mobile network notification services and in particular, to a method of notifying a customer if particular telephone numbers are in communication with the mobile network, and when a particular application associated with the telephone numbers are in use.

Cellular telephones provide convenience and safety to customers by giving customers the ability to make and receive telephone calls from any location where cellular services are available. Often times multiple cellular telephones are linked to a common account. As such, these cellular telephones share a relationship. For example, parents may share a same account with their children. In the aforementioned example, it is not unusual for users such as children to abuse cellular phone use, such as by over-using minutes, accessing certain applications and calling certain phone numbers. Currently, a caller cannot tell if a phone on a common account is abusing cellular telephone privileges. Furthermore, a caller cannot tell assert control over these abuses.

### BRIEF SUMMARY

Exemplary embodiments include a method for providing a mobile network notification service, including establishing a notification relationship between a device and the mobile network, monitoring the device for application usage on the network, generating a notification on the network related to the application usage and in response to the notification, generating a response to the application usage.

Additional exemplary embodiments include a system for providing a mobile network notification service, including a network, a device in communication with the network and a notification application residing on at least one of the network and the device, the notification application monitoring the device for application usage.

Further exemplary embodiments include a computer-readable medium having computer-executable instructions for performing a method including establishing a notification relationship between a device and the mobile network, establishing the device as subordinate and configurable by a configuration process, monitoring the device for application usage on the network, generating a notification on the network related to the application usage and in response to the notification, receiving commands in the device to control the device.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram of an exemplary system for providing a mobile network notification service;

FIG. 2 depicts an exemplary customer interface for providing a mobile network notification service;

FIG. 4 depicts an exemplary process by which a customer may provision a notification service when the notification application is implemented through a browser application that resides on a server;

FIG. 5 depicts alternate exemplary embodiments that may be utilized to allow a customer to provision portions of a notification service through an application that resides partially in the customer telephone and partially on a server;

FIG. 6 depicts an exemplary telephone call process for utilizing a mobile network notification service;

FIG. 7 depicts an exemplary setup process for notification; and

FIG. 8 depicts an exemplary telephone call process for utilizing a mobile network notification service.

The detailed description explains the exemplary embodiments, together with advantages and features, by way of example with reference to the drawings.

### DETAILED DESCRIPTION OF EXEMPLARY EMBODIMENTS

Exemplary embodiments provide the ability for a mobile telephone customer of a provider network to know when another mobile customer of the provider network (or another provider network that has partnered with the provider network or partnering Internet Service Providers (ISP's)) has their telephone turned on in the mobile network, and to know when the other mobile customer has initiated and engaged in certain activities. Given this knowledge, the mobile telephone customer may then call the other mobile customer or send the other mobile customer a message using an instant messaging facility or can alternatively assert control over the activities. The ability to determine if another mobile customer has their telephone turned on in the mobile network and has initiated certain activities may be provided by a network-based solution utilizing a browser for provisioning. Alternatively, these abilities may be provided by utilizing software that communicates with the provider network and has been loaded into a cellular telephone (e.g., at point of purchase, downloaded, flash upgrade). Exemplary embodiments create an option for a mobile telephone customer who enters a telephone number into the telephone memory to allow other mobile subscriber customers to see when the customer's telephone is powered on and within the mobile network, and alternatively to allow other who enters a telephone number into the telephone memory to allow other mobile subscriber customers to see when and how the customer's telephone has initiated and engaged in certain activities.

In exemplary embodiments, the notification service may be supported by utilizing the information that is communicated to a home location register (HLR) or location server regarding the status of mobile subscribers. A modification to the existing software on an HLR may be written to manage this, or alternatively an additional server may be created to specifically manage the status of mobile customers. Software is installed on customer telephones to run the notification application. The notification application manages the list of the individual mobile customers and their status. The application also communicates with the mobile network to send and receive status updates.

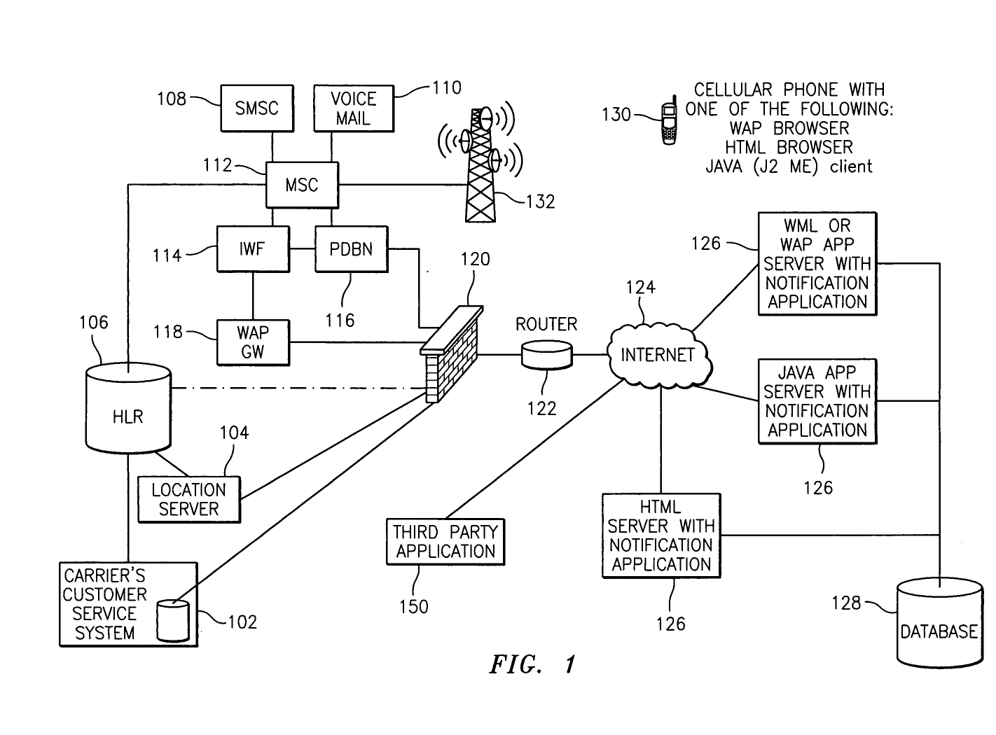

FIG. 1 is a block diagram of an exemplary system for providing a mobile network notification service. The system includes a cellular telephone 130 containing connection software such as a wireless application protocol (WAP) browser or a hypertext markup language (HTML) browser when the notification application resides on an application server 126. Alternatively, the cellular telephone 130 may include a Java client (e.g. J2ME, binary runtime environment for wireless (BREW), other similar client) or any other type of client known in the art when portions of the notification application reside in the cellular telephone 130 and other portions of the notification application reside on an application server 126. The system depicted in FIG. 1 includes a standard wireless telephone network environment with elements including a base station 132 for receiving telephone calls from cellular telephones 130, a mobile switching center (MSC) 112 in communication with a short messaging service center 108 (SMSC), a voice mail system 110, a home location register 106 (HLR), an IWF 114 and a packet data backbone network 116 (PDBN). The IWF 114 is also in communication with a wireless application protocol gateway 118 (WAP GW).

The HLR 106, as is known in the art, includes a database of customer (subscriber) information including customer profiles utilized in mobile (cellular) networks. In addition, the HLR 106 accesses customer information from the carrier's customer service system 102 and a location server 104. In exemplary embodiments, the HLR 10 records whether the customer is a subscriber to the notification service. If the customer is a subscriber, the HLR 106 sends a message to the notification application via a network 124, such as the Internet, when the customer telephone 130 is powered on and in the mobile network. In exemplary embodiments, the HLR 106 sends information to the notification application through a firewall 120 and via a router 122 and the network 124.

In alternate exemplary embodiments, the location server 104 extracts base station 132, or cell site, location information from the HLR 106 and device specific location information (e.g., GPS based location) from the device, or telephone 130. The location server 104 may then make this location information available to the application servers 126. Alternatively, the HLR 106 may take the location information from the location server 104 and send it to the application servers 126.

The network 124 depicted in FIG. 1 may be any type of known network including, but not limited to, a wide area network (WAN), a local area network (LAN), a global network (e.g. Internet), a virtual private network (VPN), and an intranet. The network 124 may be implemented using a wireless network or any kind of physical network implementation known in the art.

FIG. 1 also includes a database for storing notification application data. The storage device 128 depicted in FIG. 1 may be implemented using a variety of devices for storing information. It is understood that the storage device 128 may be implemented using memory contained in one or more of the server systems 126 or it may be a separate physical device. The storage device 128 is logically addressable as a consolidated data source across a distributed environment that includes a network 124. The physical data accessed via the storage device 128 may be located in a variety of geographic locations depending on application and access requirements. Information stored in the storage device 128 may be retrieved and manipulated via the server systems 126. The storage device 128 includes a notification database. In exemplary embodiments, the notification database is relational and includes one or more records correlating a mobile telephone customer with other mobile telephone customers that have allowed the mobile telephone customer to view their current mobile telephone status. In an exemplary implementation, permission to view status can be an automatic service for one or more master cellular telephones with relation with subordinate cellular telephones. For example, in a family account, the parents can have master cellular telephones and the children can have subordinate cellular telephones, which automatically submit to notification to the master cellular telephones when certain activities on the subordinate cellular telephones are initiated and engaged.

The storage device 128 may also include other kinds of data such as information concerning the creating and modification of the notification database records (e.g., date and time of creation). In exemplary embodiments, one or more of the server systems 126 operate as a database servers and coordinate access to application data including data stored on storage device 128.

Storage device 128 can further include physical location data, such as data provided by global positioning systems (GPS) and advanced forward link trilateration (AFLT), and whether or not and to whom a subscriber has allowed this physical position information. Storage device 128 can further include moment-to-moment physical location data as to where someone is positioned as well as their “rabbit tracks”, that is the trail that shows where a person has been up to a point in time. In general, storage medium can store information related to three GPS satellites, which in turn pinpoints position, which can be sent to location server 104 and stored in storage device 128. In general, the device 130 calculates its position with an algorithm and sends that to location server 104 in the network 124 and then that server 104 in the network 124 can make that available to those that have permission.

The application servers 126 execute one or more computer programs to facilitate the notification process. The processing is described in more detail below and may include having all of the notification application residing on the server 126 or sharing the processing of the notification application between the server 126 and the cellular telephone 130. All or portions of the notification application may be located on a server 126 such as a wireless markup language (WML) or wireless application protocol (WAP) server, an HTML server, a Java application server, or a BREW application server. In exemplary embodiments of the present invention, portions of the notification application may also be located on the cellular telephone 130.

It is appreciated that the system can include a number of in-network options and applications that are available to device 130, such as telephony, messaging, call logs, etc. There may be also a number of off-network applications 150 available to the device 130 such as web browsing, e-commerce, etc. For example, the device 130 may be able to download ring-tones from a variety of sources. As discussed in the description above, a master user of a master device may want to monitor the use of a subordinate user with a subordinate device, and alternatively take control of the subordinate device based on certain activities.

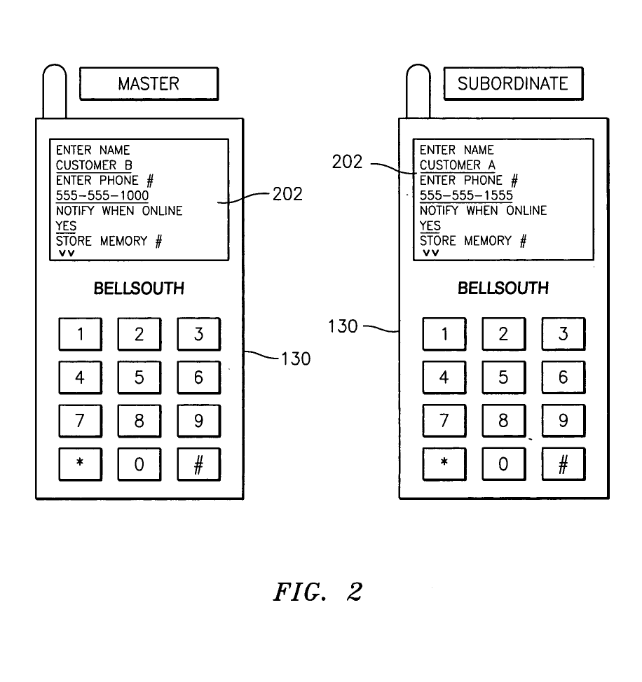

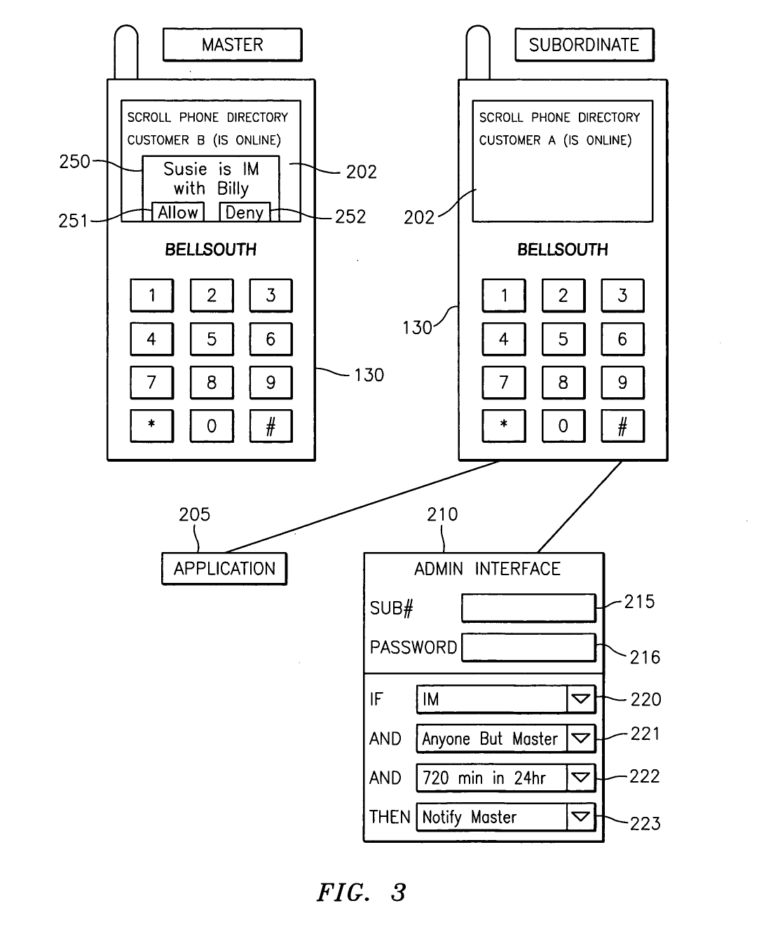

FIG. 2 depicts an exemplary customer interface for providing a mobile network notification service. Exemplary embodiments send and receive updates to and from the mobile network regarding the availability status and the use of certain applications with respect to the subordinate device. For example, as depicted in FIG. 2, Master and Subordinate can load each other's telephone number into both of their telephones 130. Master's telephone communication area 202 includes Subordinate's name, telephone number and instructions to notify Subordinate when Master is connected to the mobile network. Subordinate also includes applications that monitor the use of the Subordinate, the data being sent to the Master, as discussed further below. Similarly, Subordinate's telephone communication area 202 includes Master's name, telephone number and instructions to notify Master when Subordinate is connected to the mobile network. However, Master's device further includes the ability to monitor the use on Subordinate and to assert control over the Subordinate, as discussed further below. In addition, Subordinate processes screens in the telephone communication area 202 to request notification of Master and vice-versa. In response to processing these screens, the notification service application 126 checks the status of Master and Subordinate periodically to determine the status of their telephones 130. Furthermore, notification service application 126 receives data related to the usage of Subordinate to notify Master of the usage. Notification service application further allows Master to assert control over Subordinate if certain activities are initiated and engaged.

FIG. 3 depicts an exemplary customer interface for providing a mobile network notification service. After the notification service application processes the screen described in reference to FIG. 2, the telephone communication areas 202 on the subscriber telephones 130 contain information about the availability status of the other subscriber. The telephone communication areas 202 of the Master can further contain monitoring and notification information that certain activities or applications have been initiated and engaged has occurred. In addition, Master can include information related to specific activities of an application, for example, that Instant Messaging has occurred between Subordinate and another specific user.

As discussed, Subordinate can include application 205. Generally, application 205 is representative of any type of application that can be used on Subordinate. Subordinate can further include control application 210 that provides the monitoring and control functionality. The control application can generally monitor and identify application 205 via an application ID, and can record the application 205 via an event descriptor record. The control application 210 can be accessed through an admin interface having a subordinate number field 215 and password field 216, generally accessible only by the Master user. The admin interface can further include criteria fields 220, 221, 222. A first criteria field 220 can include a pull down menu giving notification options. The admin interface can include additional criteria fields 221, 222 with pull down menus such that specific criteria can be entered for tailored notification criteria. For example, if Subordinate is using Instant messaging, with anyone but the Master, for a period of greater than 20 minutes in a 24-hour period, then a notification can be generated. It is appreciated that there are a variety of criteria that can be used in the criteria fields 220, 221, 222 including, but not limited to: type of application; volume; minutes used; cost of application (e.g., music downloads, etc.); keywords, etc.

In general, the action to take can be entered via pull down menu in action field 223. In general, a notification is made to the Master if the criteria are met. Master communications area 202 can include a notification field 250 that provides a notification to the Mater user. For example, if the criteria discussed above are met, then the notification field 250 can include a message “Susie (Subordinate) is IM with Billy”. The notification field can further include options to assert control over the Subordinate application 205. For example, the notification field 250 can include a button 251 to allow the application to continue and a button 252 to deny and therefore kill the application on the Subordinate. The Master can have the option to call of send a message to the Subordinate either before or after taking action over the application 205.

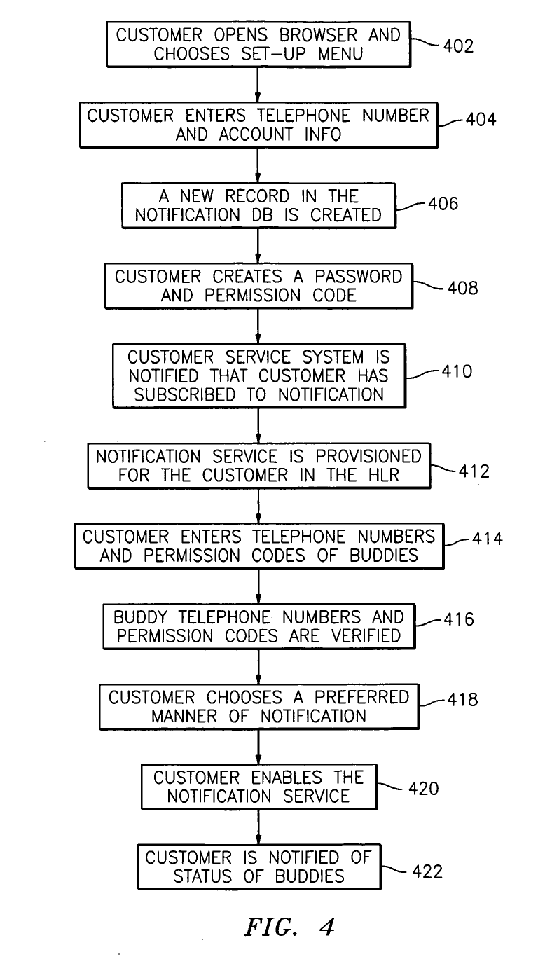

FIG. 4 depicts an exemplary process by which a customer may provision a notification service when the notification application is implemented through a browser application that resides on a server 126. In general, FIG. 4 illustrates how a family, for example, can initially set up their devices for general notification preferences with one another. The result of this process is that the mobile telephone customer has established a notification list that includes other mobile telephone customers whose status the mobile telephone customer tracks. Another result is that the notification list is enabled and therefore the status is tracked and communicated to the mobile telephone. The mobile telephone customer establishes a notification list via a web page, which may be implemented in HTML, WAP, WML or other type of browser known in the art. In other exemplary implementations, specific notification protocols can be established. In addition, as discussed above, and further below, the Master can set the criteria for monitoring and notifications regarding the use of applications.

At step 402, the mobile telephone customer opens the browser and selects the set-up menu for the notification application from the options presented in the communication area 202 on the customer telephone 130. Next, at step 404, in response to the notification application request, the customer enters his telephone number and information about the customer account that uniquely identifies the customer. The notification application then verifies the telephone number and customer information against data contained in the customer service system 102 database. If the information is not valid, then an error message is sent to the customer telephone communication area 202 via the browser and the customer is again asked to enter a telephone number and identification information. After a pre-selected number of failed attempts, the customer is advised to contact customer service.

Once the information entered by the customer is verified, step 406 is performed to create a new record in the notification database located on the storage device 128. Next, at step 408, the customer creates a customer password and permission code in response to prompting from the notification application displayed in the telephone communication area 202. The customer password allows the customer to make changes to their notification application profile (e.g., changing the notification list, disabling/enabling the notification application, deactivating the feature, setting timers, setting reason code assignments, notification preference, etc.). The notification application adds the customer password to the profile of the customer in the notification database located on the storage device 128. The permission code allows other customers to add the customer to their “buddy list.” The notification application adds the permission code entered by the customer to the profile of the customer in the notification database. At step 410, the customer service system 102 is notified that the customer has subscribed to the notification service.

Next, at step 412, the notification service is provisioned for the customer in the HLR 106. The notification service may be provisioned in the HLR 106 via “class of service” or similar means. In exemplary embodiments, the class of service for the notification feature includes a “registration trigger” and a “de-registration trigger.” The telephone 130 powers on and registers to the network, then the cases of service for this feature enables the registration trigger and sends a message to the notification application, located on a server 126, that the telephone is turned on and active in the network. When the telephone 130 is turned off and de-registers from the network, the class of service for this feature enables the de-registration trigger and sends a message to the notification application that the telephone is turned off and no longer active on the network.

At step 414, the customer enters the telephone numbers and permission codes of other customers to be added to the customer's notification list in response to prompting by the notification application. In general, it is appreciate that the Master can have control over the permissions, but that a Subordinate can't deny a Master a permission. The notification application requests the customer, via the telephone communication area 202, to enter the telephone number of another customer (i.e., a “buddy”). For security reasons, the customer must know a permission code associated with the telephone number of the buddy. The notification application requests the customer to enter the permission code associated with the buddy. At step 416, the notification application verifies that the telephone number and permission code for the buddy are valid by making a query to the notification database located on the storage device 128. If the telephone number/permission code combination entered by the customer is not valid, then an error message is sent to the customer telephone communication area 202 via the browser. The error message is displayed on the customer's telephone communication area 202. After a pre-selected number of failed attempts, the notification application tells the customer to contact their buddy and verify the permission code or call customer service. In exemplary embodiments, a subscriber can set up a “buddy list” specific to a family or other individuals whose position and presence are of particular interest, such as children.

The customer enters a preferred manner of notification at step 418 in response to prompts from the notification application. The notification application looks at the browser code for the current session and determines if the browser is associated with a mobile device and if it has “push” capability. The notification application queries the customer service system 102 and determines if the subscriber has short message service (SMS) supported by a SMSC 108 and voice mail 110. The notification application then presents the choices for notification to the customer in the customer telephone communication area 202 located on the customer telephone 130. In exemplary embodiments, the notification application presents the choices for notification to the customer in the following order, depending on the device capability of the telephone 130 and features to which the customer has subscribed: push notification via the browser or if the customer does not have a browser with this capability, the notification will be via a web page for the customer; SMS push notification; SMS pull notification; voice mail. The customer may choose one or more of these options for notification. It is appreciated that in other exemplary embodiments and implementations, a customer can select among other devices for notification, such as a personal computer, and other methods of notification, such as email, instant message, audio files, etc.

Next, at step 420, the customer enables the notification service in response to a prompt from the notification application in the telephone communication area 202. The customer may request that the application be enabled automatically each time the customer powers on the telephone 130. Alternatively, the customer may manually enable the application through a menu in the telephone communication area 202 located on the customer's telephone 130. When the notification application is enabled, the application sets a flag in the notification database to show that the customer has enabled it, and a step 422, the application notifies the customer of all buddies who are on the cellular telephone network and who have enabled their notification application in the preferred manner(s) selected by the customer. This selection can be made each time the phone is powered, or can be pre-selected or modified during device use.

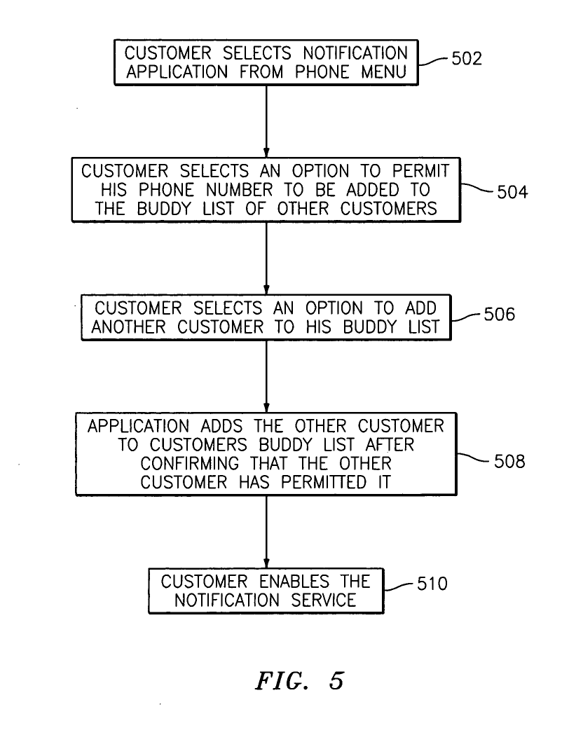

FIG. 5 depicts alternate exemplary embodiments that may be utilized to allow a customer to provision portions of a notification service through an application that resides partially in the customer telephone 130 and partially on a server 126. The notification application may be installed in the telephone 130 during manufacture or it may be downloaded into the telephone 130 on a JAVA (e.g., J2ME) application or similar download application. The notification application contains the address book for the customer and the ability to communicate with network components to know if any of the telephone numbers in the address book are active on the network at any time, and for the case of a Master, the usage of particular applications. The customer may enter telephone numbers in the address book using the notification application located on the telephone 130. The notification application gives the customer the option to make the telephone number just entered part of the “buddy list.” The customer also has an option in the menu of the telephone 130 to permit his number to be added to the notification list of other customers. In addition, the customer has the ability to use the menu of the telephone to enable or disable the notification feature. When the feature is enabled, all other buddies who have enabled the notification feature receive a notification when their “buddies” turn on their telephones 130 (register to the network). Also, they receive notification when their “buddies” sign off of the network. Notifications regarding application usage are sent from the Subordinate to the Master.

Referring still to FIG. 5, where the application is split between a telephone 130 and a server 126, the customer may request the location of his “buddies” who are active on the network. The client application in the telephone 130 accesses the host application in the server 126, and then the application in the server 126 extracts the location information of the “buddy” from the location server 104. The application in the server 126 updates the location of the “buddy” in the database 128 and sends the information to the client application in the telephone 130 of the user who requested the location information. The application in the client telephone 130 displays the location information associated with the “buddy”. As such, a Master can determine location in conjunction with a notification of application usage.

Referring to FIG. 5, establishing a notification list with the address book on the customer telephone 130 begins at step 502 when the customer selects the notification application from the menu on the customer telephone 130. At step 504, the customer selects an option to permit the customer telephone number to be added to the notification list of other customers. In an exemplary implementation, the permission occurs among members who desire to know any presence of the other members, such as family members. This selection may be limited to specific telephone numbers or to any telephone number that knows the permission code associated with the customer. When the customer selects the option to turn on permission, the notification application in the telephone sends an update to the server application residing on a server 126. The first time that the customer turns on permission, the server application creates a new record in the notification database located on the storage device 128 and informs the customer service billing system that the customer has activated this feature. The server application updates the customer profile in the notification database 128 to indicate that the customer has permitted his number to be added to other customers' “buddy lists.”

At step 506, the customer selects an option to add another user to the customer's “buddy list.” When the customer creates or accesses the telephone number of another customer, the customer may enable an option to add the telephone number to the customer's “buddy list.” At step 508, the telephone portion of the notification application adds the other customer to the customer's notification list after confirming that the other customer has permitted the notification. The notification application in the telephone 130 then sends the updated notification list information to the server application located on an application server 126. The server application checks the notification database 128 for the new telephone number that the customer wants to add to the notification list and confirms that the owner of this telephone number has permitted this customer to add the number to his “buddy list.” If the telephone number has permission to be added to the customer notification list, the server application updates the customer profile in the database with the new “buddy list.” In addition, the server application instructs the portion of the notification application located in the telephone 130 to illuminate an icon next to the telephone number in the address book, to indicate that the number is on the “buddy list.” In an exemplary implementation, the icon can blink, change color, or otherwise change appearance if a particular application has been enabled that meet the aforementioned criteria, in addition with a notification in the communications area 202 of the Master. If the number does not have permission to be added to the customer “buddy list,” the server application sends to a message to the telephone communication area 202 of the customer telephone 130 that says that the owner of the telephone number has not granted permission to add this number to the notification list or that the owner of this telephone number does not use the notification service.

The customer may enable the notification service at step 510 by using an option in the telephone 130. When the application is enabled or disabled, the notification application located in the telephone 130 sends a message to the server notification application. The server notification application updates the customer profile in the notification database to show the status of notification application for this customer as either enabled or disabled. As discussed above, by enabling or disabling the notification application, a notification is generated to those customers who have permission and who are monitoring the application usage of the device.

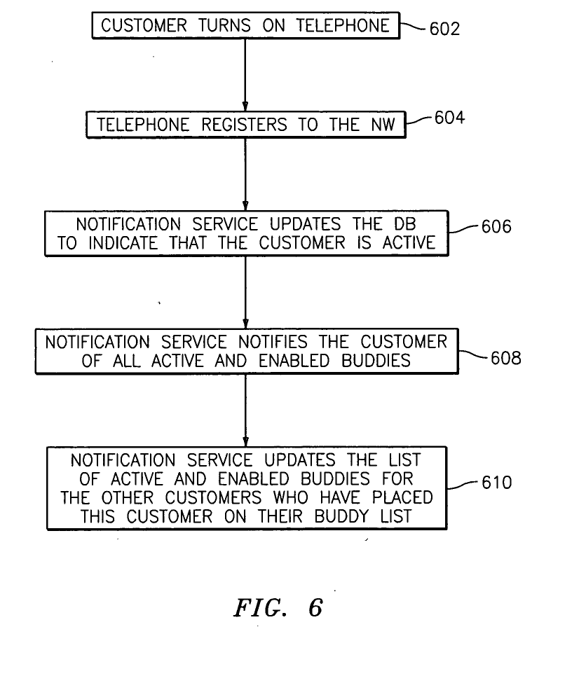

FIG. 6 depicts an exemplary telephone call process for utilizing a mobile network notification service. At step 602, the customer powers on the telephone 130 and at step 604, the telephone 130 is registered to the network. As part of registering to the network, the HLR 106 sets a record to indicate that the telephone 130 is on the network. Next, at step 606, the notification service updates the notification database, located on the storage device 128, to indicate that the customer is active. In exemplary embodiments, the HLR 106 has a feature that is associated with the notification application. This feature is a class of service or similar means. The class of service for this feature has a registration trigger and a de-registration trigger. When the telephone 130 turns on and registers to the network, the class of service for this feature enables the registration trigger and sends a message to the notification application that the telephone 130 is powered on and active on the network. When the notification application is split between the telephone 130 and a server 126, the message is sent to the server portion of the notification application. The notification application (server portion when portions of the application reside on the telephone 130) updates the customer profiles in the notification database to indicate that the customer is active on the telephone network and then it queries the database to see if the notification application is enabled. If the notification application has not been enabled at this point, then the customer must manually enable the application by opening the notification application from the menu located in the telephone communication area 202 of the telephone 130 and choosing the option to enable the notification application.

At step 606, the notification service updates the notification database to indicate that the customer is active. The notification application (server portion when portions of the application reside on the telephone 130) scans the notification list for the customer and checks the profile of all of the customers on the notification list to see which have enabled the application and which also have telephones that are active on the network. If portions of the notification application reside in the telephone 130, then the server application sends a message to the application in the telephone 130 that illuminates the icons next to the telephone numbers of all active and enabled “buddies” associated with the customer's “buddy list.” In exemplary implementations, the icons can be selectively enabled to indicate a change, as mentioned above, to indicate that a certain application usage has occurred.

In alternate exemplary embodiments, which include having the notification application located on a server 126 and accessed via a browser, the notification application creates a list of all active and enabled “buddies” associated with the customer's “buddy list.” The application notifies the customer of the list of all active and enabled “buddies” using one of the following manners as defined in the customer profile in the notification database: the application makes this list available to the customer on a web page; using the push capability in the browser, the application send the list of active and enabled “buddies” to the customer; using the SMS feature, the application sends the list via SMS; or using the voice mail system 110, the application creates a voice record of the list and makes this available as a menu feature in the voice mail system. As discussed above, it is further contemplated that when certain application usage has occurred, the notification can be generated via other capabilities such as an instant message, email, etc.

At step 610, the notification service (server portion when portions of the application reside on the telephone 130) updates the list of active and enabled “buddies” for the other customers who have place list customer on their “buddy list.” If the customer turns off their telephone 130, the class of service feature utilizes the de-registration trigger and sends a message to the host application that the customer has turned off their telephone 130. The notification application (server portion when portions of the application reside on the telephone 130) updates the customer profile in the notification database to show that the customer is no longer active on the network. In addition, the notification application (server portion when portions of the application reside on the telephone 130) notifies all other customers that have placed this customer on their notification list that this customer is not available. If the customer manually disable the notification feature, and the notification application is split between the telephone 130 and a server 126, then the application in the telephone sends a message to the server application to disable the notification feature. The notification application (server portion when portions of the application reside on the telephone 130) updates the customer profile in the notification database to show that the feature is not enabled for this customer. Also, the notification application (server portion when portions of the application reside on the telephone 130) sends a message to the customers who have placed this customer on the notification list to generate a change to the icon next to this customer's telephone number to indicate that the customer is not available.

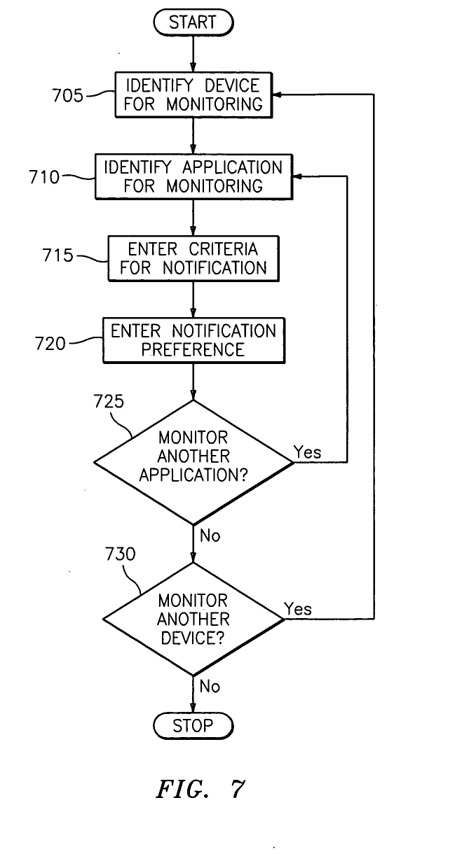

FIG. 7 depicts an exemplary setup process for notification. As discussed above, a Master user can choose to identify device on the Master plan to monitor and to assert control over certain application use. As further discussed above, a Subordinate device can include a monitoring program 210 that can be configured by the Master user for monitoring and notification to the Master device. The set up process for the Subordinate devices via application 210 is now discussed with respect to FIG. 7. At step 705, the Master user can identify the device that the user desires to monitor and control. At step 710, the user can further identify the application 205 that he/she desires to monitor. As discussed above, the applications can be monitored can include, but are not limited to: telephony; instant messaging; e-commerce, browsers, call logs, etc. The user can then configure the criteria for notification at step 715. The different types of criteria were discussed above with respect to FIG. 3. At step 720, the user can further enter the notification preference, which can simply be a notification. The notification preferences can also include an option to kill the application 205, send a warning message to the Subordinate device, limit the use of the Subordinate device, etc. At step 725, the user can choose to configure another application on the Subordinate device. If the user chooses to configure another application, then the user can repeat steps 710-720, with respect to the same device. If the user does not want to configure another application at step 725, the user can then decide whether or not to configure another device at step 730. If the user wants to configure another device at step 730, then the user repeats steps 705-720 with respect to a new selected device. If the user does not want to configure another device, then the set-up process stops.

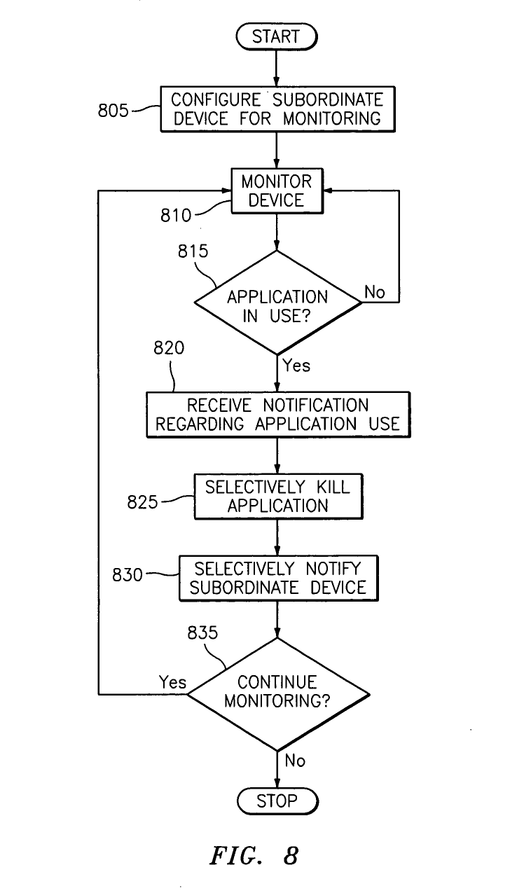

FIG. 8 depicts an exemplary telephone call process for utilizing a mobile network notification service. At step 805, the subordinate device is configured for monitoring as discussed in FIG. 7. At step 810, the subordinate device is monitored. At step 815, monitoring continues by determining whether or not the configured application is in use. If the application is not is use at step 815, the device monitoring continues at step 810. It is appreciated that the application may never be put into use, thus the monitoring loop at steps 810, 815 may continue indefinitely.

If the application is in use at step 815, then a notification is received by the Master device at step 820. In general, the Master device is notified of the application in use via an application ID. If desired, the Master device can also review the event descriptor record to determine further details of the application use. As discussed above, there are a variety of ways in which the Master device can be notified of the application use. In one option, the Master device can take control over the application by killing the application at step 825. If desired, the Master device can further send a message at step 830 to the subordinate device that the Master device is aware of the application use and has killed the application. The message can also indicate a warning against using the application. It is understood that there are many types of messages that can be generated at step 835. The Master device can then determine whether or not to continue monitoring at step 835. If the Master device continues to monitor at step 835, then step 810 is repeated. If the Master device does not continue to monitor at step 835, then the process ends. It is appreciated that at any time, the Master device can choose to reconfigure an application, add other configured applications or configure new devices for monitoring.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for providing a mobile network notification service, comprising:
establishing a notification relationship between a device and the mobile network;
monitoring the device for application usage on the network;
generating a notification on the network related to the application usage; and
in response to the notification, generating a response to the application usage.

2. The method as claimed in claim 1 wherein establishing the notification relationship comprises:
establishing the device as subordinate; and
configuring the device to receive commands to control an application residing on the device.

3. The method as claimed in claim 2 wherein the commands terminate the application.

4. The method as claimed in claim 1 further comprising configuring the device to monitor for application usage.

5. The method as claimed in claim 4 wherein application usage includes at least one of: telephony; messaging; e-commerce; and browsing.

6. The method as claimed in claim 1 wherein establishing the notification relationship comprises establishing the device as subordinate to a master device that allows the subordinate device to be at least one of configured by the master device, monitored by the master device, and controlled by the master device

7. The method as claimed in claim 6 further receiving a message from the network in the device related to the application usage.

8. The method as claimed in claim 1 wherein generating a response to the application usage is terminating the application usage.

9. The method as claimed in claim 1 wherein generating a response to the application usage is limiting the application usage.

10. A system for providing a mobile network notification service, comprising:
a network;
a device in communication with the network; and
a notification application residing on at least one of the network and the device, the notification application monitoring the device for application usage.

11. The system as claimed in claim 10 wherein the notification application includes instructions to configure the device to monitor application usage.

12. The system as claimed in claim 11 wherein the notification application includes instructions to receive control commands in the device.

13. The system as claimed in claim 12 wherein the control commands include commands to terminate the application usage.

14. The system as claimed in claim 10 further comprising a graphical user interface including a display and a selection device

15. The system as claimed in claim 14 wherein the notification application includes instructions to:
retrieve a set of menu entries, each of the menu entries representing a notification criterion and a notification preference;
display the set of menu entries on the display;
receive a plurality of menu entry selection signals indicative of the selection device pointed at a selected menu entry from the set of menu entries; and
in response to the signal, configuring the device to monitor application usage and provide notification to the network, represented by the selected menu entries.

16. The system as claimed in claim 10 further comprising a device application residing on the device.

17. The system as claimed in claim 16 wherein the device application usage includes at least one of: telephone; message; e-commerce; and browser.

18. A computer-readable medium having computer-executable instructions for performing a method comprising:
establishing a notification relationship between a device and the mobile network;
establishing the device as subordinate and configurable by a configuration process;
monitoring the device for application usage on the network;
generating a notification on the network related to the application usage; and
in response to the notification, receiving commands in the device to control the device.

19. The computer readable medium as claimed in claim 18, wherein the configuration process comprises instructions to:
set-up notification criteria based on application usage; and
set-up notification preferences.

20. The computer readable medium as claimed in claim 18, wherein receiving commands in the device to control the device includes receiving commands to terminate the application usage.
